(19) United States
(12) Patent Application Publication
(10) Pub. No.: US 2004/0179622 A1
(43) Pub. Date: Sep. 16, 2004

(54) Method of performing a simon's or a shor's quantum algorithm and relative quantum gate

(75) Inventors: Antonino Calabro, Villa San Giovanni (IT); Domenico Porto, Catania (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.I., Agrate Brianza (MI) (IT)

(21) Appl. No.: 10/736,237

(22) Filed: Dec. 15, 2003

(30) Foreign Application Priority Data
Dec. 13, 2002 (IT) VA2002A000069

(51) Int. Cl. H04B 14/04

(52) U.S. Cl. 375/242

(57) ABSTRACT

A method for performing a Simon's or Shor's quantum algorithm over a function encoded with n qubits is provided. The method includes performing a superposition operation over a set of input vectors for generating a superposition vector, performing an entanglement operation for generating a corresponding entanglement vector, and performing an interference operation for generating a corresponding output vector. The superposition operation is carried out in a comparably fast manner by generating the superposition vector by identifying the non-null components thereof and by calculating, as a function of the n qubits, the value ½^{n/2} of all the non-null components of the superposition vector, and by calculating indices of these components according to an arithmetic succession. The seed of this calculation is 1 and the common difference is 2ⁿ. The method may be implemented in a quantum gate.

### FIELD OF THE INVENTION

The present invention relates in general to quantum algorithms, and in particular, to a method and a corresponding quantum gate for performing Simon's and Shor's algorithms without the need for storing very large matrices.

### BACKGROUND OF THE INVENTION

Quantum algorithms are global random searching algorithms based on the principles, laws and quantum effects of quantum mechanics. They are used for controlling a process or for processing data in a database. They are particularly useful in performing intelligent processes of search-of-minima intelligent operations.

In quantum search operations, each design variable is represented by a finite linear superposition of classical initial states. Through a sequence of elementary unitary steps the initial quantum state |i> (for the input) is manipulated in such a way that a measurement of the final state of the system yields the correct output. Usually, in the quantum search algorithm three principal operators are used, namely: linear superposition (coherent states), entanglement, and interference.

For a better understanding of the field of application of the invention, a brief description of quantum search algorithms is provided.

A Survey of Quantum Algorithms:

The problems solved by quantum algorithms may be stated as follows:

| | |
|---|---|
| Input | A function f: {0, 1}ⁿ → {0, 1}^{m} |
| Problem | Find a certain property of f |

The structure of a quantum algorithm is outlined, in a high level representation, by the diagram of FIG. 1.

The input of a quantum algorithm is always a

BOX 1: UNITARY MATRIX U_{F}

A squared matrix U_{F} on the complex field is unitary
if its inverse matrix coincides with its conjugate
transpose:
U_{F}⁻¹ = U_{F}^{†}
A unitary matrix is always reversible and preserves
the norm of vectors.

function f of a binary string into a binary string. This function is represented as a map table, defining for each string its image. The function f is first encoded into a unitary matrix operator U_{F} depending on the f properties. This operator calculates f when its input and output strings are encoded into canonical base vectors of a complex Hilbert space: U_{F} maps the vector code of every string into the vector code of its image by f.

Once the matrix operator U_{F} has been generated, it is embedded into a quantum gate G. The quantum gate G is a unitary matrix whose structure depends on the form of the matrix U_{F} and on the problem to be solved. The quantum gate is the core of a quantum algorithm. In every quantum algorithm, the quantum gate acts on the initial canonical base of vectors (a same vector may always be chosen) to generate a complex linear combination (superposition) of base vectors as output. This superposition contains all the information to answer the initial problem.

After having made such a superposition, a measurement is done to extract this information. In quantum mechanics, a measurement is a non-deterministic operation that produces as output only one of the base vectors of the operation of superposition. The probability of each base vector being the output of the measurement depends on its complex coefficient (probability amplitude) of entering in the complex linear combination.

Each single operation of the quantum gate and the measurement form a quantum block. The quantum block is repeated k times to produce a collection of k base vectors. Since the measurement is a non-deterministic operation, these basic vectors will not necessarily be identical and each one of them encodes the information needed to solve the problem. The last part of the algorithm includes the interpretation of the collected base vectors to obtain with a certain probability the right answer to the initial problem.

Encoder:

The behavior of the encoder block is described in the detailed schematic diagram of FIG. 2. Function f is encoded into matrix U_{F} in three steps.

Step 1:

The map table of function f:{0, 1}ⁿ→{0, 1}^{m} is transformed into the map table of the injective function F:{0, 1}^{n+m}→{0, 1}^{n+m} such that:

F(x₀, . . . , xₙ₋₁, y₀, . . . , yₘ₋₁)=(x₀, . . . , xₙ₋₁, f(x₀, . . . , xₙ₋₁)⊕(y₀, . . . , yₘ₋₁)) (1)

BOX 2: XOR OPERATOR ⊕

```
The XOR operator between two binary strings p and q
of length m is a string s of length m such that the
i-th digit of s is calculated as the exclusive OR
between the i-th digits of p and q:
            p=(p₀, . . . , pₙ₋₁)
            q=(q₀, . . . , qₙ₋₁)
s = p ⊕ q = ((p₀ + q₀) mod 2, . . . , (pₙ₋₁ + qₙ₋₁) mod 2)
```

The need to deal with an injective function comes from the requirement that U_{F} be unitary. A unitary operator is reversible, so it cannot map two different inputs to the same output. Given that U_{F} is the matrix representation of F, F must be infective. Should the matrix representation of function f be used, a non-unitary matrix may result, since f could be non-injective. Therefore, injectivity is assured by increasing the number of bits and by considering the function F instead of the function f. Anyway, function f can always be calculated from F by putting (y₀, . . . , yₘ₋₁)=(0, . . . , 0) in the input string and reading the last m values of the output string.

Step 2:

The map table of function F is transformed into map table U_{F}, according to the following formula:

∀sε{0, 1}^{n+m}:U_{F}[τ(s)]=τ[F(s)] (2)

The coding map τ:{0, 1}^{n+m}→c²^{^{n+m}} (c²^{^{n+m}} is the target complex Hilbert space) is such that:

$$τ ( 0 ) = ( \begin{matrix}1 \\ 0\end{matrix} ) = \vert 0 ⟩ τ ( 1 ) = ( \begin{matrix}1 \\ 0\end{matrix} ) = \vert 1 ⟩ \\ τ ( {x}_{0} , … , {x}_{n + m - 1} ) = τ ( {x}_{0} ) ⊗ … ⊗ τ ( {x}_{n + m - 1} ) = \vert {x}_{0} … {x}_{n + m - 1} ⟩ \qquad ( 3 )$$

$BOX 3 \text{:} VECTOR TENSOR PRODUCT ⊗$
The tensor product between two vectors of dimensions h
and k is a tensor product of dimension h · k, such that:
$\vert x ⟩ ⊗ \vert y ⟩ = ( \begin{matrix}{x}_{1} \\ ⋯ \\ {x}_{h}\end{matrix} ) ⊗ ( \begin{matrix}{y}_{1} \\ ⋯ \\ {y}_{k}\end{matrix} ) = ( \begin{matrix}{x}_{1} {y}_{1} \\ ⋯ \\ {x}_{1} {y}_{k} \\ ⋯ \\ {x}_{h} {y}_{1} \\ ⋯ \\ {x}_{h} {y}_{k}\end{matrix} ) ⟹ \begin{matrix}\underline{Physical interpretation :} \\ \text{If a component of a complex vector is interpreted as the probability amplitude of a system being in a given state (indexed by the component number), the tensor product between two vectors described the joint probability amplitude of two systems being in a joing state.}\end{matrix}$

### EXAMPLES: VECTOR TENSOR PRODUCTS

$$\begin{matrix}( 0 \text{,} 0 ) {⟶}^{τ} ( \begin{matrix}1 \\ 0\end{matrix} ) ⊗ ( \begin{matrix}1 \\ 0\end{matrix} ) = ( \begin{matrix}1 \\ 0 \\ 0 \\ 0\end{matrix} ) = \vert 00 ⟩ & ( 0 \text{,} 1 ) {⟶}^{τ} ( \begin{matrix}1 \\ 0\end{matrix} ) ⊗ ( \begin{matrix}0 \\ 1\end{matrix} ) = ( \begin{matrix}0 \\ 1 \\ 0 \\ 0\end{matrix} ) = \vert 01 ⟩ \\ ( 1 \text{,} 0 ) {⟶}^{τ} ( \begin{matrix}0 \\ 1\end{matrix} ) ⊗ ( \begin{matrix}1 \\ 0\end{matrix} ) = ( \begin{matrix}0 \\ 0 \\ 1 \\ 0\end{matrix} ) = \vert 10 ⟩ & ( 1 \text{,} 1 ) {⟶}^{τ} ( \begin{matrix}0 \\ 1\end{matrix} ) ⊗ ( \begin{matrix}0 \\ 1\end{matrix} ) = ( \begin{matrix}0 \\ 0 \\ 0 \\ 1\end{matrix} ) = \vert 11 ⟩\end{matrix}$$

Code τ maps bit values into complex vectors of dimension 2 belonging to the canonical base of c². Moreover, using tensor products, τ maps the general state of a binary string of dimension n into a vector of dimension 2ⁿ, and reducing this state to the joint state of the n bits forms the register. Every bit state is transformed into the corresponding 2-dimension base vector and then the string state is mapped into the corresponding 2ⁿ-dimension base vector by composing all bit-vectors through tensor products. In this sense, a tensor product is the vector counterpart of state conjunction.

Base vectors are denoted using the ket notation |i>. This notation is taken from Dirac's description of quantum mechanics.

Step 3:

The map table of U_{F} is transformed into the matrix U_{F} by using the following transformation rule:

[U_{F}]ᵢⱼ=1 [symbol] U_{F}j>=|i> (4)

which can be easily understood by considering the vectors |i> and |j> as column vectors. Because these vectors belong to the canonical base, U_{F} defines a permutation map of the rows of the identity matrix. In general, row |j> is mapped into row |i>. This rule will be illustrated more in detail in a sample quantum algorithm, namely the Shor's algorithm.

Quantum Block:

The core of the quantum block is the quantum gate, which depends on the properties of the matrix U_{F}. The scheme of FIG. 3 gives a more detailed description of the quantum block. In FIG. 3, the matrix operator U_{F} is the output of the encoder block represented in FIG. 2. Here, it becomes the input for the quantum block.

This matrix operator is first embedded into a more complex gate: the quantum gate G. Unitary matrix G is applied k times to an initial canonical base vector |i> of dimension 2^{n+m}. Every time, the resulting complex superposition G|0 . . 01 . . 1> of base vectors is measured, producing as a result one base vector |xᵢ>. All the measured base vectors {|x₁>, . . , |xₖ>} are collected together. This collection is the output of the quantum block.

The intelligence of such algorithms rests in the ability to build a quantum gate that is able to extract the information necessary to find the required property of f and to store it into the output vector collection. The structure of the quantum gate for every quantum algorithm will be discussed in detail, observing that a general description is possible. To represent quantum gates some special diagrams called quantum circuits will be used.

An example of a quantum circuit, relative to the so called Deutsch-Jozsa's quantum algorithm, is illustrated in FIG. 4. Every rectangle is associated to a matrix 2ⁿ×2ⁿ, where n is the number of lines entering and leaving the rectangle. For example, the rectangle marked U_{F} is associated to the matrix U_{F}. Typically, matrix H represents a Hadamard rotation:

$$H = \frac{1}{\sqrt{2}} [ \begin{matrix}1 & 1 \\ 1 & - 1\end{matrix} ] \qquad ( 5 )$$

Quantum circuits provide a high-level description of the gate, and by using some transformation rules that are listed in FIGS. 5a to 5f, it is possible to compile them into the corresponding gate-matrix.

$BOX 4 \text{:} MATRIX TENSOR PRODUCT ⊗$
The tensor product between two matrices X_{n×m} and Y_{h×k}
is a (block) matrix (n · h) × (m · k) such that:
$X ⊗ Y = [ \begin{matrix}{x}_{11} Y & … & {x}_{1 m} Y \\ … & … & … \\ {x}_{n1} Y & … & {x}_{nm} Y\end{matrix} ] with X = [ \begin{matrix}{x}_{11} & … & {x}_{1 m} \\ … & … & … \\ {x}_{n1} & … & {x}_{nm}\end{matrix} ]$

### EXAMPLE: MATRIX TENSOR PRODUCT

$$[ \begin{matrix}1 & 2 \\ 3 & 4\end{matrix} ] ⊗ [ \begin{matrix}5 & 6 \\ 7 & 8\end{matrix} ] = [ \begin{matrix}1. [ \begin{matrix}5 & 6 \\ 7 & 8\end{matrix} ] \\ 3. [ \begin{matrix}5 & 6 \\ 7 & 8\end{matrix} ]\end{matrix} \begin{matrix}2. [ \begin{matrix}5 & 6 \\ 7 & 8\end{matrix} ] \\ 4. [ \begin{matrix}5 & 6 \\ 7 & 8\end{matrix} ]\end{matrix} ] = [ \begin{matrix}5 & 6 & 10 & 12 \\ 7 & 8 & 14 & 16 \\ 15 & 18 & 20 & 24 \\ 21 & 24 & 28 & 32\end{matrix} ]$$

The manner of using these rules will become clearer when a first sample of a quantum algorithm will be illustrated.

Decoder:

The decoder block has the function of interpreting the base vectors collected after the iterated execution of the quantum block. Decoding these vectors means to retranslate them back into binary strings and interpreting them directly if they already contain the answer to the starting problem. Alternatively, they may be used as coefficient vectors for some system of equations to obtain the sought solution. This part will not be discussed in detail because it is relatively straightforward.

To better illustrate a field of application of the invention, a brief description of the Shor's algorithm is given.

Shor's Algorithm:

Shor's problem is so stated:

Given an integer number N, find a factor p for N.

This problem seems to be different from the other problems solved by quantum algorithms, but it can be reduced to an equivalent problem with the same form as the other quantum problems. This reduction is made possible by a result of the theory of numbers that relates the period r of a special periodic function to the factors of an integer N. This function is:

ƒ_{N,a}: [symbol] → [symbol] such that ƒ_{N,a}(x)=a^{x}modN

where a is a random number coprime to N, namely:

gcd(a, N)=1

where gcd(x, y) is the greatest common divisor between x and y.

This function is periodic (the period is at most N). Let the period be r. Then:

ƒ_{N,a}(0)=ƒ_{N,a}(r) a^{r}≡1modN

If the period is even, this equation can be rewritten as:

(a^{r/2})²≡1modN [symbol] (a^{r/2})²1≡0modN [symbol] (a^{r/2}−1)(a^{r/2}+1)≡0modN

This means:

∃hε [symbol] :(a^{r/2}−1)(a^{r/2}+1)=hN

So, unless (a^{r/2}−1)≡0modN or (a^{r/2}+1)≡0modN, namely a^{r/2}≡±1modN, at least one of a^{r/2}+1 or a^{r/2}−1 must have a non-trivial factor in common with N. It may be found by calculation:

gcd(a^{r/2}−1,N) gcd(a^{r/2}+1,N).

Using this reduction, the true question becomes: “What is the period of f?” Since the period of this function is less than N, it may be restricted to the interval [0, 1, . . . , N−1]. Every input value is coded as a binary string. A number of bits n=[log N] (eventually [log N]+1) is needed to code all the N possible input values.

Therefore, Shor's problem is translated into the following standard quantum problem:

| | |
|---|---|
| Input | f: {0, 1}ⁿ → {0, 1}ⁿ with period r |
| Problem | Find r |

Encoder:

First a simple example will be dealt with, then conclusions will be generalized.

A. Introductory example:

Consider the case:

N=4 [symbol] n=2; a=3

Then, map table f is:

TABLE 1

| (x₀, x₁) | f(x₀, x₁) |
|---|---|
| 00 | 01 |
| 01 | 11 |
| 10 | 01 |
| 11 | 11 |

The period of this function is r=2.

Step 1:

Function f is encoded into the injective function F built using eq. (2). Therefore, the map table of F is as follows:

TABLE 2

| (x₀, . . . , xₙ₋₁, y₀, . . . , yₙ₋₁) | F(x₀, . . . , xₙ₋₁, y₀, . . . , yₙ₋₁) |
|---|---|
| 0000 | 0001 |
| 0100 | 0111 |
| 1000 | 1001 |
| 1100 | 1111 |
| 0001 | 0000 |
| 0101 | 0110 |
| 1001 | 1000 |
| 1101 | 1110 |
| 0010 | 0011 |
| 0110 | 0101 |
| 1010 | 1011 |
| 1110 | 1101 |
| 0011 | 0010 |
| 0111 | 0100 |
| 1011 | 1010 |
| 1111 | 1100 |

Step 2:

The function F is encoded into the map table of the operator U_{F}:

TABLE 3

| \|x₀ . . . xₙ₋₁ y₀ . . . yₙ₋₁> | U_{F}\|x₀ . . . xₙ₋₁ y₀ . . . yₙ₋₁> |
|---|---|
| \|0000> | \|0001> |
| \|0100> | \|0111> |
| \|1000> | \|1001> |
| \|1100> | \|1111> |
| \|0001> | \|0000> |
| \|0101> | \|0110> |
| \|1001> | \|1000> |
| \|1101> | \|1110> |
| \|0010> | \|0011> |
| \|0110> | \|0101> |
| \|1010> | \|1011> |
| \|1110> | \|1101> |
| \|0011> | \|0010> |
| \|0111> | \|0100> |
| \|1011> | \|1010> |
| \|1111> | \|1100> |

Step 3:

The matrix corresponding to U_{F} is obtained by using the rule:

[U_{F}]ᵢⱼ=1 [symbol] U_{F}|j>=|i>

or in other words by observing that the first two vectors in the input tensor product are left unchanged, whereas the operator acting on the last two is chosen inside the set {I\mathring{x}I, I\mathring{x}C, C\mathring{x}I, C\mathring{x}C} wherein I is the identity matrix and C is the complement matrix, depending on the values of the first two vectors:

TABLE 4

| U_{F} | \|00> | \|01> | \|10> | \|11> |
|---|---|---|---|---|
| \|00> | I [symbol] C | 0 | 0 | 0 |
| \|01> | 0 | C [symbol] C | 0 | 0 |
| \|10> | 0 | 0 | I [symbol] C | 0 |
| \|11> | 0 | 0 | 0 | C [symbol] C |

This matrix preserves the first two vectors and it preserves the third vector, flipping the fourth vector when the second vector is |0>; and flipping the third and fourth vectors when the second vector is |1>.

It is worth noting that the block matrix in cell (i, i) is identical to the block matrix in cell ((i+r)modN, (i+r)modN) where i is the binary label of the vector marking the matrix row and column of the cell.

B. Case with n=2:

In general, if n=2, a different value will be taken and so a different period r will be obtained, and the operator still maps the first n vectors into themselves but the block matrix pattern on the main diagonal changes.

The matrix U_{F} has the following form:

TABLE 5

| U_{F} | \|00> | \|01> | \|10> | \|11> |
|---|---|---|---|---|
| \|00> | M₀₀ | 0 | 0 | 0 |
| \|01> | 0 | M₀₁ | 0 | 0 |
| \|10> | 0 | 0 | M₁₀ | 0 |
| \|11> | 0 | 0 | 0 | M₁₁ |

where Mᵢε{I\mathring{x}I, I\mathring{x}C, C\mathring{x}I, C\mathring{x}C} and Mᵢ=Mⱼ [symbol] ((j=i) OR (j=(i+r)modN)) .

C. General Case:

Through a similar reasoning the following general form for the matrix U_{F} when n>0 may be proposed:

TABLE 6

| U_{F} | \|0 . . . 0> | \|0 . . . 1> | . . . | \|1 . . . 1> |
|---|---|---|---|---|
| \|0 . . . 0> | M₀ . . . 0 | 0 | . . . | 0 |
| \|0 . . . 1> | 0 | M₀ . . . 1 | . . . | 0 |
| . | . | . | . | . |
| . | . | . | . | . |
| . | . | . | . | . |
| \|1 . . . 1> | 0 | 0 | 0 | M₁ . . . 1 |

where Mᵢ=P₁\mathring{x} . . \mathring{x}Pₙ, Pₖε{I, C}, k=1, . . , n and Mᵢ=Mⱼ [symbol] ((j=i)OR(j=(i+r)modN)). The column labels are base vectors of dimension n.

Quantum Block:

The Shor's quantum gate may be described with the quantum circuit of FIG. 6. Shor's quantum gate shown in FIG. 7 is very similar to Simon's quantum gate shown in FIG. 8, unless for the last operator.

In Simon's algorithm the operator ⁿH is applied to the first n vectors exiting from U_{F}. This operator of the Simon's algorithm is responsible for the deletion of some of the cells in the first column of the final gate and this produces a special superposition of base vectors as output. By measuring this superposition it is possible to solve the Simon's problem.

In Shor's algorithm the interference operator is not ⁿH, in fact the main diagonal pattern of U_{F} is different, and therefore a different interference operator is needed to extract the information. This operator is represented by the matrix QFTₙ, called Quantum Fourier Transform of order n. This operator is non-classical because it maps a base vector into a complex linear combination of base vectors. In general, a base vector |i> is mapped into the linear combination α₁y₁+ . . +α₂_{ⁿ}y₂_{ⁿ} where αᵢ and αᵢ₊₁ have the same absolute value ½^{n/2} but they are phase shifted i·(2π/2ⁿ) starting with αᵢ=½^{n/2}. The operator is defined as follows:

TABLE 7

| | Φ=0 | Φ=2π/2ⁿ | . . . | Φ=(2ⁿ−1) 2π/2ⁿ |
|---|---|---|---|---|
| QFTₙ | \|0 . . . 0> | \|0 . . . 1> | . . . | \|1 . . . 1> |
| \|0 . . . 0> | 1/2^{n/2} | 1/2^{n/2} | . . . | 1/2^{n/2} |
| \|0 . . . 1> | 1/2^{n/2} | 1/2^{n/2} e^{J2π/2}^{ⁿ} | . . . | 1/2^{n/2} e^{J(2}^{ⁿ}^{-1)2π/2}^{ⁿ} |
| . | . | . | | . |
| . | . | . | | . |
| . | . | . | | . |
| \|1 . . . 1> | 1/2^{n/2} | 1/2^{n/2} e^{J(2}^{ⁿ}^{-1)2π/2}^{ⁿ} | . . . | 1/2^{n/2} e^{J(2}^{ⁿ}⁻¹⁾^{²}^{2π/2}^{ⁿ} |

where J is the imaginary unit. By using the transformation rules shown in FIGS. 5a to 5f to the circuit of FIG. 6, the quantum gate of FIG. 7 is obtained.

A discussion of the form of these gates for a few particular cases will follow and the observations will then be generalized.

A. Introductory Example:

If n=2, the quantum gate has the following form:

G=(QFT₂\mathring{x}²I)·U_{F}·(²H\mathring{x}²I)

This gate is now calculated for the first considered example:

TABLE 8

| ²H [symbol] ²I | \|00> | \|01> | \|10> | \|11> |
|---|---|---|---|---|
| \|00> | ²I/2 | ²I/2 | ²I/2 | ²I/2 |
| \|01> | ²I/2 | −²I/2 | ²I/2 | −²I/2 |
| \|10> | ²I/2 | ²I/2 | −²I/2 | −²I/2 |
| \|11> | ²I/2 | −²I/2 | −²I/2 | ²I/2 |

The matrix U_{F} has been already presented in TABLE 4, therefore

TABLE 9

| U_{F} (²H [symbol] ²I) | \|00> | \|01> | \|10> | \|11> |
|---|---|---|---|---|
| \|00> | I [symbol] C/2 | I [symbol] C/2 | I [symbol] C/2 | I [symbol] C/2 |
| \|01> | C [symbol] C/2 | −C [symbol] C/2 | C [symbol] C/2 | −C [symbol] C/2 |
| \|10> | I [symbol] C/2 | I [symbol] C/2 | −I [symbol] C/2 | −I [symbol] C/2 |
| \|11> | C [symbol] C/2 | −C [symbol] C/2 | −C [symbol] C/2 | C [symbol] C/2 |

If n=2, QFT₂ is as follows:

TABLE 10

| | Φ=0 | Φ=π/2 | Φ=π | Φ=3π/2 |
|---|---|---|---|---|
| QFT₂ | \|00> | \|01> | \|10> | \|11> |
| \|00> | 1/2 | 1/2 | 1/2 | 1/2 |
| \|01> | 1/2 | J/2 | −1/2 | −J/2 |
| \|10> | 1/2 | −1/2 | 1/2 | −1/2 |
| \|11> | 1/2 | −J/2 | −1/2 | J/2 |

TABLE 11

| QFT₂ [symbol] ²I | \|00> | \|01> | \|10> | \|11> |
|---|---|---|---|---|
| \|00> | ²I/2 | ²I/2 | ²I/2 | ²I/2 |
| \|01> | ²I/2 | J ²I/2 | −²I/2 | −J ²I/2 |
| \|10> | ²I/2 | −²I/2 | ²I/2 | −²I/2 |
| \|11> | ²I/2 | −J ²I/2 | −²I/2 | J ²I/2 |

The table defining the quantum gate G is calculated as follows:

TABLE 12

| G | \|00> | \|01> | \|10> | \|11> |
|---|---|---|---|---|
| \|00> | (I [symbol] C+C [symbol] C)/2 | (I [symbol] C−C [symbol] C)/2 | 0 | 0 |
| \|01> | 0 | 0 | (I [symbol] C+JC [symbol] C)/2 | (I [symbol] C− |
| | | | | JC [symbol] C)/2 |
| \|10> | (I [symbol] C−C [symbol] C)/2 | (I [symbol] C+C [symbol] C)/2 | 0 | 0 |
| \|11> | 0 | 0 | (I [symbol] C−JC [symbol] C)/2 | (I [symbol] C+ |
| | | | | JC [symbol] C)/2 |

By applying the operator G to the vector |0000> the following is obtained:

$$G \vert 0000 ⟩ = \vert 00 ⟩ \frac{1}{2} ( I ⊗ C + C ⊗ C ) \vert 00 ⟩ + \vert 10 ⟩ \frac{1}{2} ( I ⊗ C - C ⊗ C ) \vert 00 ⟩ .$$

If a measurement of this vector is made and the first two vectors of dimension 2 are encoded back into their binary labels, the possible results are:

00 with probability 0.5

10 with probability 0.5

The distance between these values is d=[|10−00|]₁₀[10]₁₀=2, where [s]₁₀ is the decimal representation of the binary string s. It should be observed that N/r=4/2=2, therefore d=N/r. If r is unknown, it may be calculated as:

r−N/d.

B. Case with n=2, r=2:

As shown above, when n=2, the quantum gate has the following form:

G=(QFT₂\mathring{x}²I)·U_{F}·(²H\mathring{x}²I)

by using the matrices calculated in the introductory example and recalling U_{F} given by TABLE 5.

TABLE 13

| U_{F} (²H [symbol] ²I) | \|00> | \|01> | \|10> | \|11> |
|---|---|---|---|---|
| \|00> | M₀₀/2 | M₀₀/2 | M₀₀/2 | M₀₀/2 |
| \|01> | M₀₁/2 | −M₀₁/2 | M₀₁/2 | −M₀₁/2 |
| \|10> | M₁₀/2 | M₁₀/2 | −M₁₀/2 | −M₁₀/2 |
| \|11> | M₁₁/2 | −M₁₁/2 | −M₁₁/2 | M₁₁/2 |

By recalling the expression of the interference operator QFT₂\mathring{x}²I shown in TABLE 11, the following generalized form of G is obtained:

TABLE 14

| G | \|00> | \|01> | \|10> | \|11> |
|---|---|---|---|---|
| \|00> | (M₀₀+M₀₁+M₁₀+M₁₁)/4 | (M₀₀−M₀₁+M₁₀−M₁₁)/4 | (M₀₀+M₀₁−M₁₀−M₁₁)/4 | (M₀₀−M₀₁−M₁₀+M₁₁)/4 |
| \|01> | (M₀₀+JM₀₁−M₁₀−JM₁₁)/4 | (M₀₀−JM₀₁−M₁₀+JM₁₁)/4 | (M₀₀+JM₀₁+M₁₀+JM₁₁)/4 | (M₀₀−JM₀₁+M₁₀−JM₁₁)/4 |
| \|10> | (M₀₀−M₀₁+M₁₀−M₁₁)/4 | (M₀₀+M₀₁+M₁₀+M₁₁)/4 | (M₀₀−M₀₁−M₁₀+M₁₁)/4 | (M₀₀+M₀₁−M₁₀−M₁₁)/4 |
| \|11> | (M₀₀−JM₀₁−M₁₀+JM₁₁)/4 | (M₀₀+JM₀₁−M₁₀−JM₁₁)/4 | (M₀₀−JM₀₁+M₁₀−JM₁₁)/4 | (M₀₀+JM₀₁+M₁₀+JM₁₁)/4 |

If r=2, like in our introductory example, then M₀₀=M₁₀≠M₀₁=M₁₁. This means:

TABLE 15

| G | \|00> | \|01> | \|10> | \|11> |
|---|---|---|---|---|
| \|00> | (M₀₀+M₀₁)/2 | (M₀₀−M₀₁)/2 | 0 | 0 |
| \|01> | 0 | 0 | (M₀₀+JM₀₁)/2 | (M₀₀−JM₀₁)/2 |
| \|10> | (M₀₀−M₀₁)/2 | (M₀₀+M₀₁)/2 | 0 | 0 |
| \|11> | 0 | 0 | (M₀₀−JM₀₁)/2 | (M₀₀+JM₀₁)/2 |

Consider the application of G to vector |0000>:

$$G \vert 0000 ⟩ = \vert 00 ⟩ \frac{1}{2} ( {M}_{00} + {M}_{01} ) \vert 00 ⟩ + \vert 10 ⟩ \frac{1}{2} ( {M}_{00} - {M}_{01} ) \vert 00 ⟩ .$$

If a measurement is done on this vector and the first two vectors of dimension 2 are encoded back into their binary labels, then the possible results are:

00 with probability 0.5

10 with probability 0.5

These results that were obtained for our introductory example and the same conclusions hold.

C. General Case:

As already shown, for a general case, the operator U_{F} is defined as in TABLE 6. The quantum gate G will now be calculated for a general situation:

TABLE 16

| ⁿH [symbol] ⁿI | \|0 . . . 0> | . . . | \|j> | . . . | \|1 . . . 1> |
|---|---|---|---|---|---|
| \|0 . . . 0> | ⁿI/2^{n/2} | . . . | ⁿI/2^{n/2} | . . . | ⁿI/2^{n/2} |
| \|0 . . . 1> | ⁿI/2^{n/2} | . . . | (−1)^{(0...1)·j} | . . . | −ⁿI/2^{n/2} |
| | | | (ⁿI/2^{n/2}) | | |
| . | . | | . | | . |
| . | . | | . | | . |
| . | . | | . | | . |
| \|i> | ⁿI/2^{n/2} | . . . | (−1)^{i·j}(ⁿI/2^{n/2}) | . . . | (−1)^{i·(1...1)} (ⁿI/2^{n/2}) |
| . | . | | . | | . |
| . | . | | . | | . |
| . | . | | . | | . |
| \|1 . . . 1> | ⁿI/2^{n/2} | . . . | (−1)^{(1...1)·j} | . . . | (−1)^{(1...1)·(1...1)} |
| | | | (ⁿI/2^{n/2}) | | (ⁿI/2^{n/2}) |

TABLE 17

| UF · | | | | | |
|---|---|---|---|---|---|
| (ⁿH [symbol] ⁿI) | \|0 . . . 0> | . . . | \|j> | . . . | \|1 . . . 1> |
| \|0 . . . 0> | M_{0...0}/2^{n/2} | . . . | M_{0...0}/2^{n/2} | . . . | M_{0...0}/2^{n/2} |
| . | . | | . | | . |
| . | . | | . | | . |
| . | . | | . | | . |
| \|i> | Mᵢ/2^{n/2} | . . . | (−1)^{1·j} Mᵢ/2^{n/2} | . . . | (−1)^{i·(1...1)} Mᵢ/2^{n/2} |
| . | . | | . | | . |
| . | . | | . | | . |
| . | . | | . | | . |
| \|1 . . . 1> | M_{1...1}/2^{n/2} | . . . | (−1)^{(1...1)·j} | . . . | (−1)^{(1...1)·(1...1)} |
| | | | M_{1...1}/2^{n/2} | | M_{1...1}/2^{n/2} |

Observe that:

$${[ QFT ]}_{i , j} = \frac{1}{{2}^{n / 2}} {ⅇ}^{{j [ ⅈ ]}_{10} \frac{{[ j ]}_{10} \cdot 2 π}{{2}^{n}}}$$

where [i]₁₀ and [j]₁₀ are the decimal representations of the binary strings i and j. Therefore:

TABLE 18

| QFTₙ [symbol] ⁿI | \|0 . . . 0> | . . . | \|j> | . . . | \|1 . . . 1> |
|---|---|---|---|---|---|
| \|0 . . . 0> | ⁿI/2^{n/2} | . . . | ⁿI/2^{n/2} | . . . | ⁿI/2^{n/2} |
| . | . | | . | | . |
| . | . | | . | | . |
| . | . | | . | | . |
| \|i> | ⁿI/2^{n/2} | . . . | ⁿI/2^{n/2}e^{J[i]}^{₁₀}^{·[j]}^{₁₀}^{2π/2}^{ⁿ} | . . . | ⁿI/2^{n/2} |
| | | | | | e^{J[i]}^{₁₀}^{·(2}^{ⁿ}^{-1)2π/2}^{ⁿ} |
| . | . | | . | | . |
| . | . | | . | | . |
| . | . | | . | | . |
| \|1 . . . 1> | ⁿI/2^{n/2} | . . . | ⁿI/2^{n/2}e^{J(2}^{ⁿ}^{-1)·[j]}^{₁₀}^{2π/2}^{ⁿ} | . . . | ⁿI/2^{n/2} |
| | | | | | e^{J(2}^{ⁿ}⁻¹⁾^{²}^{2π/2}^{ⁿ} |

The quantum gate G has the following form:

TABLE 19

| G | \|0 . . . 0> | . . . |
|---|---|---|
| \|0 . . . 0> | 1/2ⁿΣ_{k∈{0,1}}_{ⁿ} e^{Jπ·0·[k]}^{₁₀}^{/2}^{ⁿ⁻¹}⁾ Mₖ | . . . |
| . | . | |
| . | . | |
| . | . | |
| \|i> | 1/2ⁿΣ_{k∈{0,1}}_{ⁿ} e^{Jπ·[i]}^{₁₀}^{·[k]}^{₁₀}^{/2}^{ⁿ⁻¹} Mₖ | . . . |
| . | . | |
| . | . | |
| . | . | |
| \|1 . . . 1> | 1/2ⁿΣ_{k∈{0,1}}_{ⁿ} e^{Jπ·(2}^{ⁿ}^{-1)·[k]}^{₁₀}^{/2}^{ⁿ⁻¹} Mₖ | . . . |

Consider the term:

½ⁿΣ_{kε{0,1}}_{ⁿ}e^{Jπ·[i]}^{₁₀}^{·[k]}^{₁₀}^{/2}^{ⁿ⁻¹}Mₖ

Since Mᵢ=P₁\mathring{x} . . \mathring{x}Pₙ, Pₖε{I, C}, k=1, . . , n and Mᵢ=Mⱼ [symbol] ((j=i)OR(j=(i+r)modN)) this term may be written as:

½ⁿΣ_{hεR}[e^{Jπ·[i]}^{₁₀}^{·[h]}^{₁₀}^{/2}^{ⁿ⁻¹}+e^{Jπ·[i]}^{₁₀}^{·[h]}^{₁₀}^{+1r)/2}^{ⁿ⁻¹}+ . . +e^{Jπ·[i]}^{₁₀}^{·([h]}^{₁₀}^{+(l}^{ₖ}^{-1)r)/2}^{ⁿ⁻¹}]Mₕ

or:

½ⁿΣ_{hεR}(−1)^{[h]}^{₁₀}^{[i]}^{₁₀}^{/2}^{ⁿ⁻¹}[(−1)^{0r[i]}^{₁₀}^{/2}^{ⁿ⁻¹}+(−1)^{1r[i]}^{₁₀}^{/2}^{ⁿ⁻¹}+ . . +(−1)^{(l}^{ₕ}^{-1)r[i]}^{₁₀}^{/2}^{ⁿ⁻¹}]Mₕ

where R={0 . . 0, 0 . . 1, . . , [r−1]₂}. Suppose that N is a multiple of r, then lₕ=2ⁿ/r=1 for every h. Therefore, the previous term can be transformed into:

½ⁿΣ_{hεR}(−1)^{[h]}^{₁₀}^{[i]}^{₁₀}^{/2}^{ⁿ⁻¹}[(−1)^{2·0·[i]}^{₁₀}^{/l}+(−1)^{2·1·[i]}^{₁₀}^{/l}+ . . +(−1)^{2·(l-1})·[i]^{₁₀}^{/l}]Mₕ

and finally:

½ⁿΣ_{hεR}(−1)^{[h]}^{₁₀}^{[i]}^{₁₀}^{/2}^{ⁿ⁻¹}[e^{J·0·(2π[i]}^{₁₀}^{/l)}+e^{J·1(2π[i]}^{₁₀}^{/l)}+ . . +e^{J·(l-1)(2π[i]}^{₁₀}^{/l)}]Mₕ

The term:

e^{J·0·(2π[i]}^{₁₀}^{/l)}+e^{J·1·(2π[i]}^{₁₀}^{/l)}+ . . +e^{J·(l-1)·(2π[i]}^{₁₀}^{/l)}

is the summation of the l roots of order of the unity, unless i is a multiple of l. The summation of the roots of a given order of the unity is always null.

Therefore, in the first column of G, only those cells whose row label is |i> with i multiple of l are non-null. This means that by applying G to vector |0 . . 0>, measuring the result and encoding back into their binary values the first n base vectors of dimension 2 in the resulting tensor product, only strings i, such that i=m*l for some integer m are obtained. This means: i≡0modl.

Decoder:

As for Simon's algorithm, the quantum block is repeated several times to build a collection of vectors |i> such that i≡0modl. By putting these equations in a system and solving it, the value of l is obtained. Since l=2ⁿ/r, r=2ⁿ/l is calculated.

The number of vectors necessary for calculating r depends on the technique used for solving the system of equations. In general, it is necessary to repeat the quantum block for a number of times that increases according to a polynomial rule with n.

If 2ⁿ is not a multiple of r, then lₕ=[2ⁿ/r], for some values of h, and lₕ=[2ⁿ/r]+1, for some other values of h. The term

e^{J·0(2π[i]}^{₁₀}^{/l}^{ₕ}⁾+e^{J·1(2π[i]}^{₁₀}^{/l}^{ₕ}⁾+ . . +e^{J·(l}^{ₕ}^{-1)(2π[i]}^{₁₀}^{/l}^{ₕ}⁾

is not exactly 0 when i is not a multiple of lₕ, although it approximates 0. Therefore, all possible strings may be found as a result of measurement, but strings i that do not represent a multiple of 2ⁿ/r are less likely to be found. To decrease this probability (and increase the probability of 2ⁿ/r-multiples), 2n input bits are used for encoding f. This means that more roots of the unity are involved and thus a better approximation is reached.

According to classic approaches, it is evident that the number of qubits (quantum bits) of a quantum algorithm may be a critical parameter that noticeably limits the calculation speed. In fact, by referring to the scheme of FIG. 6, it may be noticed that by adding only one qubit, the size of matrices with respect to the previous configuration is doubled and the number of multiplications to be performed grows exponentially. This fact limits the possibility of practically using the Shor's and Simon's algorithms when the number n of qubits is relatively large.

### SUMMARY OF THE INVENTION

In view of the foregoing background, an object of the present invention is to provide a faster method for performing Simon's or Shor's quantum algorithms.

Differently from known methods, and according to the method of the present invention, the superposition matrix operator is not generated and row-columns products are not carried out because only the indices of the non-null components of vectors generated by the superposition operation are calculated. In doing so, only vectors of 2ⁿ components need to be calculated and stored, resulting in a significant savings in terms of computational complexity, time and memory space.

More precisely, an object of the invention is to provide a method for performing a Simon's or Shor's quantum algorithm over a certain function f(x) encoded with a certain number n of qubits, that comprises carrying out a superposition operation over a set of input vectors and generating a superposition vector; carrying out an entanglement operation and generating a corresponding entanglement vector; and carrying out an interference operation and generating a corresponding output vector.

The method of the invention carries out the superposition operation in a comparably very fast manner because it generates the superposition vector by identifying only the non-null components thereof by calculating, as a function of the number n of qubits, the value ½^{n/2} of the non-null components of the superposition vector, and by calculating the indices of these components according to an arithmetic succession, the seed of which is 1 and the common difference is 2ⁿ. According to a preferred embodiment, similar operations are performed also for simplifying the entanglement operation.

The method of the invention may be implemented in a corresponding quantum gate that comprises a superposition subsystem carrying out a superposition operation according to a Simon's or Shor's quantum algorithm over a set of input vectors, and outputs a superposition vector. An entanglement subsystem processes components of the superposition vector, and outputs a corresponding entanglement vector. An interference subsystem processes components of the entanglement vector, and generates a corresponding output vector.

A characterizing feature of the quantum gate of the invention is based upon the superposition subsystem comprising a circuit generating a first bit string representing the value ½^{n/2} of the non-null components of the superposition vector and other 2ⁿ bit-strings each representing a respective index of the 2ⁿ non-null components of the superposition vector. A memory buffer stores the strings representing the value ½^{n/2} and the indices.

### BRIEF DESCRIPTION OF THE DRAWINGS

The various aspects and advantages of the invention will become even more evident through a detailed description referring to the attached drawings, wherein:

FIG. 1 is a block diagram of quantum algorithms according to the prior art;

FIG. 2 is a block diagram of an encoder according to the prior art;

FIG. 3 is a general structure of the Quantum Block as show in FIG. 1;

FIG. 4 is a circuit for a Deutsch-Jozsa's quantum gate according to the prior art;

FIG. 5a shows an example of tensor product transformation according to the prior art;

FIG. 5b shows an example of dot product transformation according to the prior art;

FIG. 5c shows the identity transformation according to the prior art;

FIG. 5d shows an example of a propagation rule according to the prior art;

FIG. 5e shows an example of an iteration rule according to the prior art;

FIG. 5f explains the input/output tensor rule according to the prior art;

FIG. 6 illustrates the Shor's quantum algorithm according to the prior art;

FIG. 7 illustrates the Shor's quantum gate according to the present invention; and

FIG. 8 illustrates the Simon's quantum gate according to the present invention.

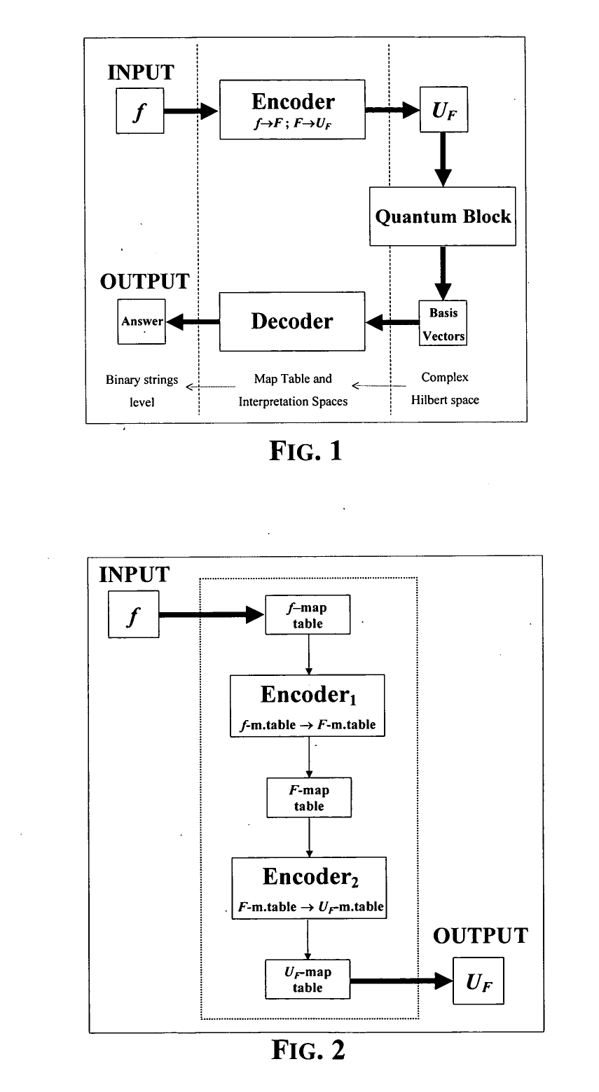

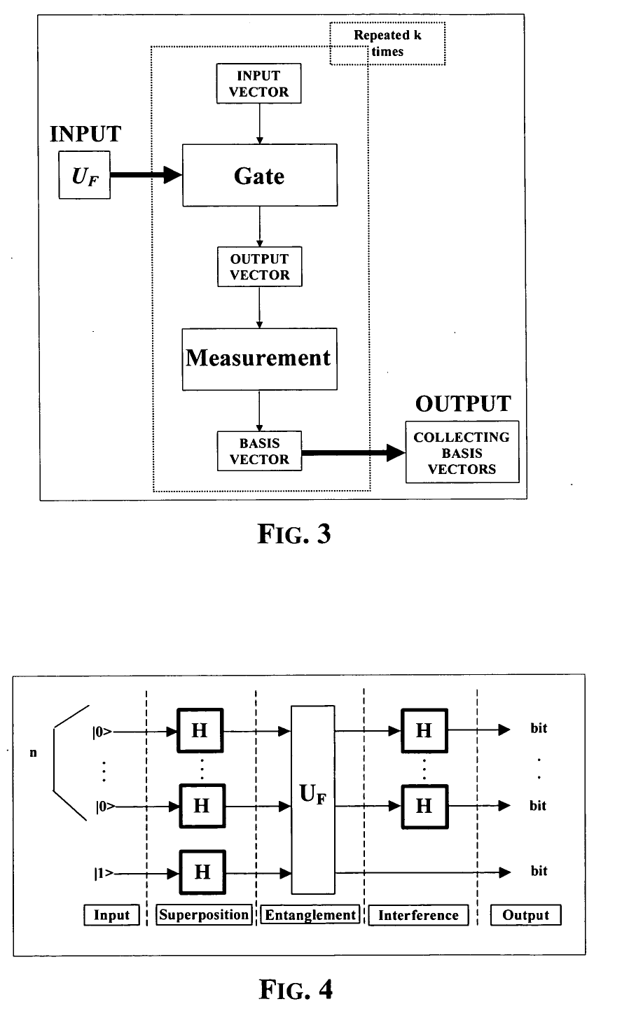

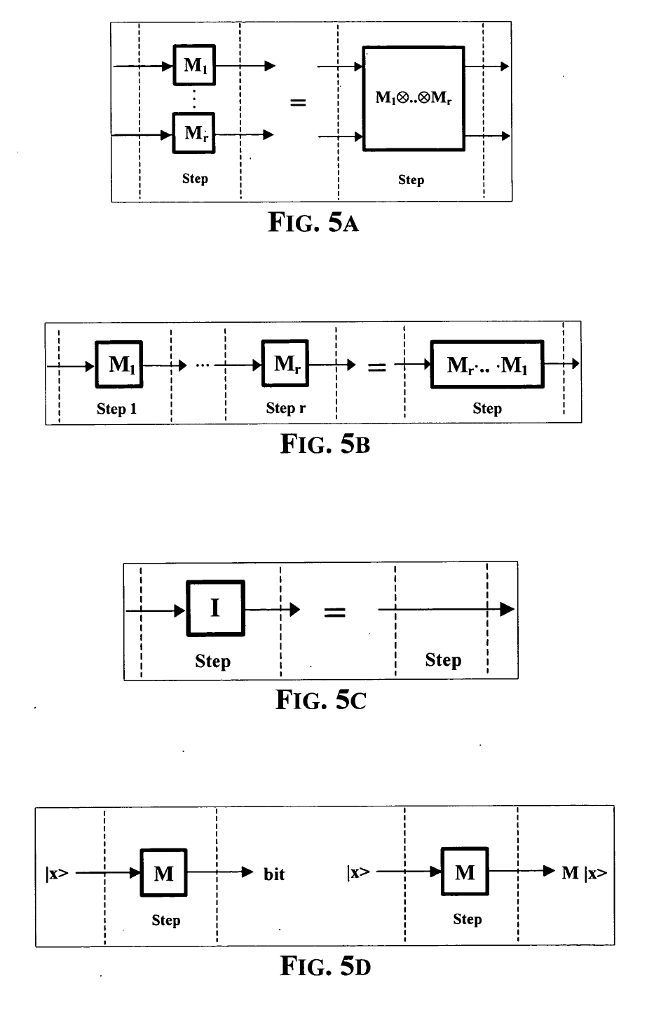

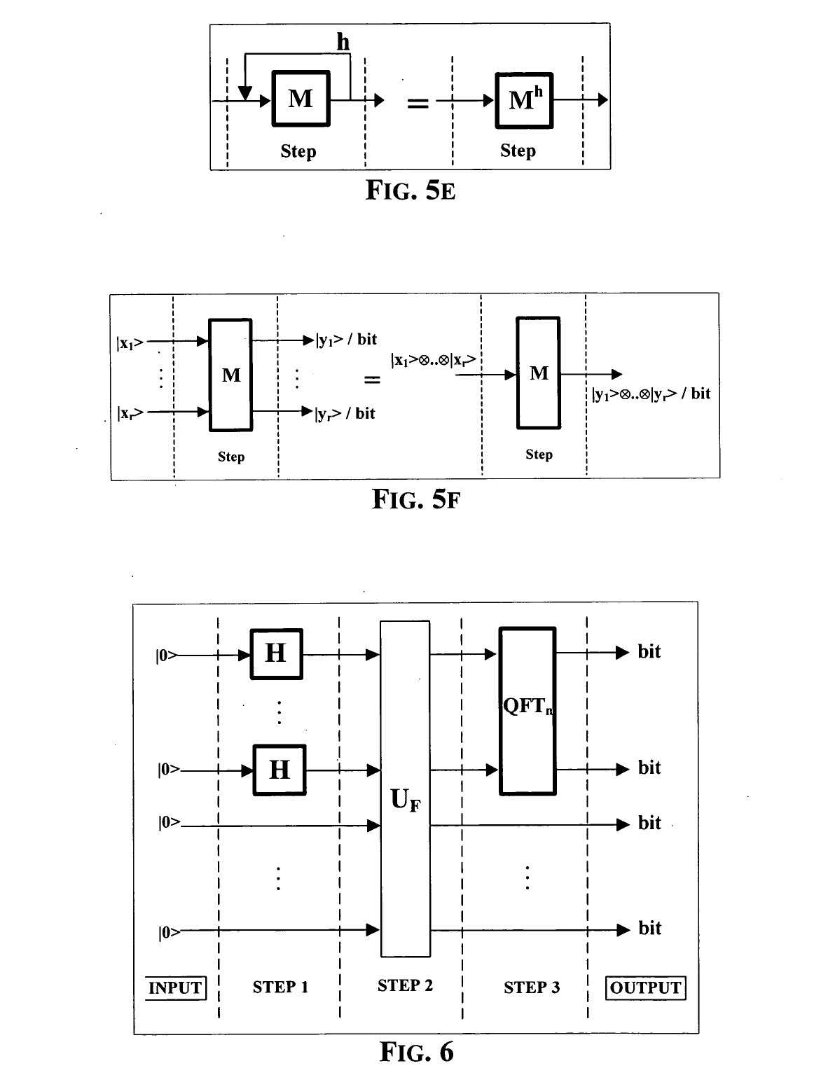

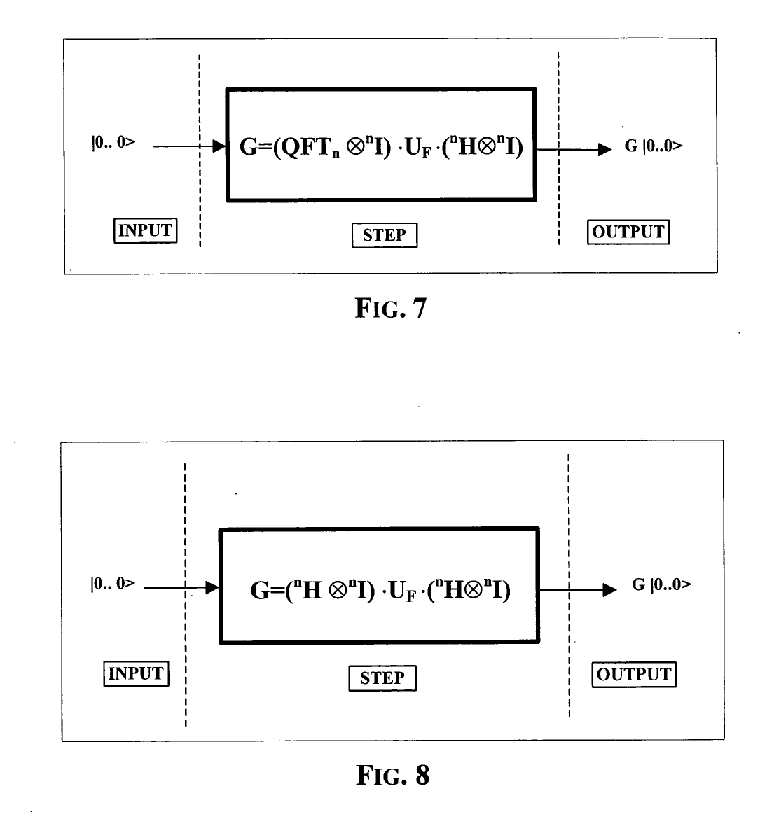

### DETAILED DESCRIPTION OF THE PREFERRED EMBODIMENTS

Both for the Shor's algorithm as well as for the Simon's algorithm, the superposition block is ⁿH\mathring{x}ⁿI. This implies that the first n qubits of the input vector are to be multiplied for ⁿH and the second n qubits are to be multiplied for ⁿI.

To better illustrate how, according to the invention, the superposition operation may be greatly simplified, consider the following example with n=3. The first 3 qubits of the vector P generated by the superposition operator are given by:

H|0>\mathring{x}H|0>\mathring{x}H|0>

Neglecting the constant ½^{3/2} (n=3), this tensor product is:

$$[ \begin{matrix}1 \\ 1\end{matrix} ] ⊗ [ \begin{matrix}1 \\ 1\end{matrix} ] ⊗ [ \begin{matrix}1 \\ 1\end{matrix} ] = {[ \begin{matrix}1 & 1 & 1 & 1 & 1 & 1 & 1 & 1\end{matrix} ]}^{T}$$

In general the vector P obtained with the superposition operation is

P=└p₁ p₂ . . . p₂ₙ ┘

wherein pᵢ=½^{n/2}.

For the considered example with n=3, this vector P is

$$P = \frac{1}{{2}^{\frac{3}{2}}} \cdot {[ \begin{matrix}1 & 1 & 1 & 1 & 1 & 1 & 1 & 1\end{matrix} ]}^{T} ⊗ {[ \begin{matrix}1 & 0 & 0 & 0 & 0 & 0 & 0 & 0\end{matrix} ]}^{T}$$

In the general case (any value of n) the components pᵢ of the vector P obtained with the superposition operation according to the Shor's or Simon's algorithm are:

$${p}_{i} = \{ \begin{matrix}\frac{1}{{2}^{n / 2}} & if i = 1 + {2}^{n} ( j - 1 ) \\ 0 & otherwise\end{matrix} \qquad ( 6 )$$

wherein j=1 . . . 2ⁿ, i=1 . . . 2²ⁿ.

The components of the superposition vector may assume only two values, only 2ⁿ of which are non-null and must be stored. An advantage with respect to the known methods is that it is no longer necessary to store the whole superposition operator ⁿH\mathring{x}ⁿI, which has 2²ⁿ×2²ⁿ components, and performing row-columns products, but it is possible instead to store only the positions of the 2ⁿ non-null components of the superposition vector. The non-null value of these components is ½^{n/2} and may be calculated immediately by knowing the number n of qubits.

According to the method of the invention, the superposition vector P is not calculated carrying out 2²ⁿ row-column products, as in the known methods, but is determined simply by calculating the positions of the 2ⁿ non-null components, the value of which is ½^{n/2}. These indices may be easily calculated, for instance in the form of bit strings with a complex programmable logic device (CPLD), by simply providing the number n of qubits. According to a preferred embodiment of the invention the entanglement operation is also made less complex from a computational point of view than in the known methods.

It has been noticed that in all quantum algorithms, the entanglement matrix U_{F} is a diagonal block matrix, the structure of which is strictly tied to the binary representation of the function f. The diagonal matrix blocks are chosen from the set formed by the identity matrix I, the complement matrix C and matrices obtained as tensor products thereof.

For instance, for the Shor's algorithm, with n=2, the diagonal matrix blocks of the matrix U_{F} are chosen from the set composed of

I\mathring{x}I, I\mathring{x}C, C\mathring{x}I, C\mathring{x}C

each having a size 2²×2². These matrix blocks may be immediately obtained from TABLE 1 noticing that, if the value 00 corresponds to a certain vector (x₀, x₁), then the matrix block on the diagonal of U_{F} in correspondence of the row |x₀,x₁> is I\mathring{x}I. Similarly, when f(x₀, x₁) is equal to 01, 10 or 11, the matrix block on the diagonal of U_{F} in correspondence of the row |x₀,x₁> is respectively equal to I\mathring{x}C, C\mathring{x}I, C\mathring{x}C. This rule is resumed in the following table:

TABLE 20

| F(x₀, x₁) = 00 | F(x₀, x₁) = 01 | f(x₀, x₁) = 10 | f(x₀, x₁) = 11 |
|---|---|---|---|
| I [symbol] I | I [symbol] C | C [symbol] I | C [symbol] C |

In general, when this bit-string is known

f(x₀, . . . , xₙ₋₁)=(z₀, . . . , zₘ₋₁)

it is possible to recognize immediately that the matrix block on the main diagonal (up-left to down-right) of U_{F} in correspondence of the row |x₀, . . . , xₙ₋₁> is:

(z₀·C+(1−z₀)·I)\mathring{x} . . . \mathring{x}(zₘ₋₁·C+(1−zₘ₋₁)·I)

This straightforward rule may be easily verified and it holds for all quantum algorithms. It allows a quick calculation of the non-null 2ⁿ matrix blocks of U_{F}, each having 2ⁿ×2ⁿ components.

By knowing the non-null matrix blocks of the matrix U_{F}, it is possible to quickly calculate the vector A obtained with the entanglement operation, recalling that only a component per each row and per each column of the matrix U_{F} is non-null. According to a preferred embodiment of the method of the invention it is possible to calculate immediately the components aₖ of the entanglement vector A without calculating any product.

In more detail, it has been observed that only the first row of each 2ⁿ×2ⁿ matrix block of the entanglement operator U_{F} gives a non-null result, because the non-null components of the superposition vector P of Shor's and Simon's algorithms are given by eq. (6). As a consequence, it is even possible to calculate the components aₖ of the entanglement vector A by directly using the following formula

$${a}_{k} = \{ \begin{matrix}\frac{1}{{2}^{n / 2}} & if k = f ( j ) + 1 + {2}^{n} ( j - 1 ) \\ 0 & otherwise\end{matrix} \qquad ( 7 )$$

wherein j=1 . . . 2ⁿ, k=1 . . . 2²ⁿ.

The result is a vector the components of which are null or assume a same non-null value that depends only on the number n of qubits. As for the superposition vector, also in this case there are only 2ⁿ non-null components having the same value, thus the entanglement vector may be determined by the indices of the 2ⁿ non-null components.

Therefore, the entanglement operation, as well as the superposition operation, may be carried out with a circuit that generates bit-strings that represent these indices and a memory buffer in which to store these strings. It is much more difficult to perform the interference operation of the Shor's algorithm. In fact, differently from the entanglement operation, the vector components are not composed exclusively by two values. Moreover the presence of tensor products, the number of which grows rapidly with n, forms a critical computational problem.

To simplify the input-output relations, certain particular properties of the matrix QFTₙ\mathring{x}ⁿI have been considered. Differently from other quantum algorithms, the interference operation in the Shor's algorithm is performed through a quantum Fourier transformation QFT. As all quantum operators, the QFT operator is a unary operator acting on complex vectors of the Hilbert space. It transforms each input vector in a superposition of base vectors of the same amplitude, but with a phase shift.

The interference matrix QFTₙ\mathring{x}ⁿI has only a few non-null components. It has 2ⁿ·(2ⁿ−1) zeroes in each column. As a consequence, it is not necessary to perform all multiplications because many of them give a null result.

Since bₕ is the components of the vector B generated with the interference operation, the real part and the imaginary part of bₕ are given by the following equations:

$$Re [ {b}_{h} ] = {\sum }_{j = 1}^{{2}^{n}} {a}_{( h mod {2}^{n} ) + 1 + {2}^{n} ( j - 1 )} cos ( 2 π \frac{( j - 1 ) \cdot int [ ( h - 1 ) / {2}^{n} ]}{{2}^{n}} )$$

$$Im [ {b}_{h} ] = {\sum }_{j = 1}^{{2}^{n}} {a}_{( h mod {2}^{n} ) + 1 + {2}^{n} ( j - 1 )} sin ( 2 π \frac{( j - 1 ) \cdot int [ ( h - 1 ) / {2}^{n} ]}{{2}^{n}} )$$

since int[.] is the function that generates the integer part of its argument and since h=1 . . 2²ⁿ.

Therefore, according to the improved method of the invention, each component is calculated simply by performing a summation of at most 2ⁿ cosine (or sine) functions and multiplying this summation for ½^{n/2}, because the non-null components of the entanglement vector A are equal to ½^{n/2}.

The improvement with respect to the known method is evident, because they contemplate the step of calculating the real and imaginary parts of the components of the output vector by performing a summation of 2²ⁿ products, thus with a significantly greater computational complexity.

That which is claimed is:

1. A method of performing a Simon's or a Shor's quantum algorithm on a given function (f(x)) encoded with a certain number n of qubits, comprising the steps of
carrying out a superposition operation according to one of said quantum algorithms over a set of input vectors, generating a superposition vector (P),
carrying out an entanglement operation (U_{F}) on said superposition vector (P), generating a corresponding entanglement vector (A),
carrying out an interference operation on
said entanglement vector (A), generating a corresponding output vector (B), and
characterized in that
said superposition vector (P) is generated through the following process steps:
calculating, in function of said number n of qubits, the value (½^{n/2}) of non null components of said superposition vector (P);
calculating indices (i) of the 2ⁿ non null components of said superposition vector as an arithmetical succession, the seed of which is 1 and the common difference of which is 2ⁿ ( i=1+2ⁿ(j−1)).

2. The method of claim 1, wherein said entanglement vector is generated through the following process steps:
calculating indices (k) of the 2ⁿ non null components of said entanglement vector (A), summing to each term of said arithmetical succession a relative number corresponding to the value of the given function (f(j)) calculated in correspondence of the number of place (j) of said term in said succession (k=ƒ(j)+1+2ⁿ(j−1));
the value of the non null components of said entanglement vector (A) being equal to that of the superposition vector (P).

3. The method of claim 2 for carrying out a Shor's quantum algorithm, comprising the operation of generating real and imaginary components (Re[bₕ], Im[bₕ]) of said output vector (B) through the following process steps:
for each index h of said real and imaginary components (Re[bₕ], Im[bₕ]), veryfying whether among the terms of the arithmetic succession
hmod2ⁿ+1+2ⁿ(j−1)
of seed hmod2ⁿ+1, index j and common difference 2ⁿ, there is at least a term corresponding to an index of a non null component of said entanglement vector;
if the above test is negative, making said real and imaginary components (Re[bₕ], Im[bₕ]) equal to zero, otherwise calculating said real component (Re[bₕ]) as the product between said value of the non null components and the summation of the following cosine functions
$$cos ( 2 π \frac{( j - 1 ) \cdot int [ ( h - 1 ) / {2}^{n} ]}{{2}^{n}} )$$
and said imaginary component (Im[bₕ]) as the product between said value of the non null components and the summation of the following sine functions
$$sin ( 2 π \frac{( j - 1 ) \cdot int [ ( h - 1 ) / {2}^{n} ]}{{2}^{n}} )$$
for all values of said index j of said arithmetical succession to which correspond indices (k) of non null components of said entanglement vector.

4. A quantum gate for performing a Simon's or a Shor's quantum algorithm on a given function (f(x)) encoded with a certain number n of qubits according to the method of claim 1, comprising
a superposition subsystem carrying out a superposition operation according to one of said quantum algorithms over a set of input vectors, generating a superposition vector (P),
an entanglement subsystem processing said superposition vector (P), generating a corresponding entanglement vector (A),
an interference subsystem processing said entanglement vector (A), generating a corresponding output vector (B), and
characterized in that
said superposition subsystem comprises a circuit generating a first bit string representing said value (½^{n/2}) of non null components of said superposition vector (P) and other 2ⁿ bit-strings each representing a respective index (i) of the 2ⁿ non null components of said superposition vector;
a memory buffer storing the strings representing said value (½^{n/2}) and said indices (i).

5. The quantum gate of claim 4, implementing the method of claim 2, wherein said entanglement subsystem comprises
a circuit generating bit-strings representing said indices (k) of the 2ⁿ non null components of said entanglement vector (A);
a second memory buffer storing said bit strings (k).
